(19) United States
(12) Patent Application Publication
(10) Pub. No.: US 2020/0394502 A1
(43) Pub. Date: Dec. 17, 2020

(54) NEUROMORPHIC COMPUTING DEVICE

(71) Applicant: MACRONIX INTERNATIONAL CO., LTD., Hsinchu (TW)

(72) Inventor: Shih-Hung CHEN, Hsinchu County (TW)

(21) Appl. No.: 16/441,106

(22) Filed: Jun. 14, 2019

(51) Int. Cl. G06N 3/063; G06N 3/04; G06N 3/08

(52) U.S. Cl. CPC G06N 3/063; G06N 3/082; G06N 3/0454

(57) ABSTRACT

A neuromorphic computing device includes first neural circuits, second neural circuits and synapse weights. The first neural circuits are disposed in a first neural region. The second neural circuits are disposed in a second neural region. The synapse weights are electrically connected between the first neural circuits and the second neural circuits, and disposed in a synapse region. The first neural region and the second neural region are on opposing sides of the synapse region respectively.

### BACKGROUND

### Technical Field

The disclosure relates to a neuromorphic computing device.

### Description of the Related Art

Recently, neuromorphic computing devices implemented by using memory arrays are proposed. Compared to those devices using processors to perform neuromorphic computations, the neuromorphic computing device has advantages of low power consumption. The neuromorphic computing device may be applied for an artificial intelligence (AI) chip.

The neuromorphic computing device usually includes a plurality of synapses, with each of which corresponds to a weighting value. When an input vector is applied to the neuromorphic computing device, the input vector is multiplied by a weighting vector consists of weighting values corresponding to one or more synapse relating to the input vector, so that a result of sum-of-product is obtained. The sum-of-product calculation is widely used in neuromorphic computing devices.

### SUMMARY

The present disclosure relates to a neuromorphic computing device.

According to an embodiment, a neuromorphic computing device is provided. The neuromorphic computing device comprises first neural circuits, second neural circuits and synapse weights. The first neural circuits are disposed in a first neural region. The second neural circuits are disposed in a second neural region. The synapse weights are electrically connected between the first neural circuits and the second neural circuits, and disposed in a synapse region. The first neural region and the second neural region are on opposing sides of the synapse region respectively.

According to another embodiment, a neuromorphic computing device is provided. The neuromorphic computing device comprises a substrate, synapse weights and neural circuits. The synapse weights are on the substrate. The neural circuits are electrically connected to the synapse weights, and disposed on a side of the synapse weights facing towards the substrate.

The above and other embodiments of the disclosure will become better understood with regard to the following detailed description of the non-limiting embodiment(s). The following description is made with reference to the accompanying drawings.

### BRIEF DESCRIPTION OF THE DRAWINGS QAS″

FIG. 1 illustrates a neuromorphic computing device according to an embodiment.

FIG. 2 illustrates a neuromorphic computing device according to an embodiment.

FIG. 3 illustrates a neuromorphic computing device according to an embodiment.

FIG. 4 illustrates a neuromorphic computing device according to an embodiment.

FIG. 5 illustrates a neuromorphic computing device according to an embodiment.

FIG. 6 illustrates a neuromorphic computing device according to an embodiment.

FIG. 7 illustrates a neuromorphic computing device according to an embodiment.

FIG. 8 illustrates a cross-section view of synapse weights having a resistor structure according to an embodiment.

FIG. 9 illustrates a top view of a neuromorphic computing device according to an embodiment.

### DETAILED DESCRIPTION

The illustrations may not be necessarily drawn to scale, and there may be other embodiments of the present disclosure which are not specifically illustrated. Thus, the specification and the drawings are to be regard as an illustrative sense rather than a restrictive sense. Moreover, the descriptions disclosed in the embodiments of the disclosure such as detailed construction, manufacturing steps and material selections are for illustration only, not for limiting the scope of protection of the disclosure. The steps and elements in details of the embodiments could be modified or changed according to the actual needs of the practical applications. The disclosure is not limited to the descriptions of the embodiments. The illustration uses the same/similar symbols to indicate the same/similar elements.

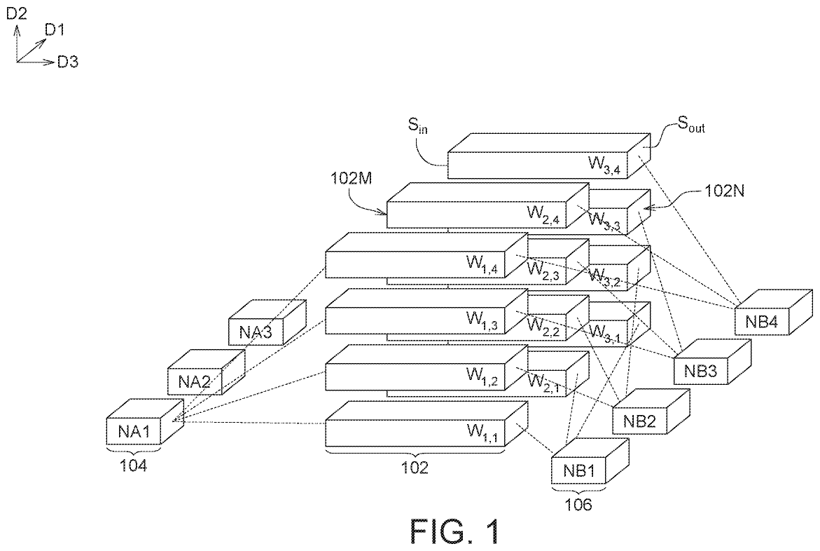

Please refer FIG. 1 which illustrates a neuromorphic computing device according to an embodiment. The neuromorphic computing device may be applied in an artificial intelligence (AI) chip which may be applied for an electronic equipment such as a car, a mobile device such as a mobile phone and so on. The neuromorphic computing device comprises synapse units and neural circuits. The neural circuits comprise first neural circuits NAi and second neural circuits NBj respectively in different neural regions. The synapse units may be electrically connected between the first neural circuits and the second neural circuits through conductor circuits.

In embodiments, each of the synapse units comprises a synapse weight W_{i,j}. Each of the synapse weights W_{i,j} comprises a signal input terminal Sin and a signal output terminal Sout. Neural signals (such as a voltage signal Vi) from the first neural circuits NAi may be transferred into the synapse weights W_{i,j} (such as a resistor) through the signal input terminals Sin by a conductor circuit and converted into weighted signals (such as a current signal Ij converted according to Ohm's law) by the synapse weights W_{i,j}, and then the weighted signals are transferred from the synapse weights W_{i,j} through the signal output terminal Sout to the second neural circuits NBj by an another conductor circuit to be sensed and/or calculated. For example, the current signals Ij may be sensed by a current sensor. The current signals Ij transferred into the second neural circuit NBj may be summed up by a computing device. In this embodiment, the signal input terminal Sin and the signal output terminal Sout are at opposing sides of the synapse weight W_{i,j} respectively. For example, in an embodiment, the synapse weight W_{i,j} comprises a resistor. In an embodiment, the signal input terminal Sin is one terminal of the resistor, and the signal output terminal Sout is the other terminal of the resistor. In an embodiment, the resistor may comprise a variable resistor. In an embodiment, the resistor may comprise a resistor circuit having a 3D array stack structure. However, the present disclosure is not limited thereto. The neural signals of the first neural circuits NAi, the synapse weights W_{i,j} and the weighted signals may comply with Ohm's law. The synapse weights W_{i,j} may comprise other suitable weight elements. For example, in an another embodiment, the synapse weight W_{i,j} may comprise a conductance, such as a conductance circuit having a 3D array stack structure. The neural signals may comprise current signals. The weighted signals may comprise voltage signals.

In this embodiment, the first neural circuits NAi comprise a first neural circuit NA1 (i.e. i=1), a first neural circuit NA2 (i.e. i=2) and a first neural circuit NA3 (i.e. i=3). The second neural circuits NBj comprise a second neural circuit NB1 (i.e. j=1), a second neural circuit NB2(i.e. j=2), a second neural circuit NB3 (i.e. j=3) and a second neural circuit NB4 (i.e. j=4). The synapse weights W_{i,j} comprise synapse weights W_{1,1} to W_{1,4}, synapse weights W_{2,1} to W_{2,4}, and synapse weights W_{3,1} to W_{3,4}. In other embodiments, amounts of the first neural circuit, and/or the second neural circuit, and/or the synapse weight may be varied according to demands.

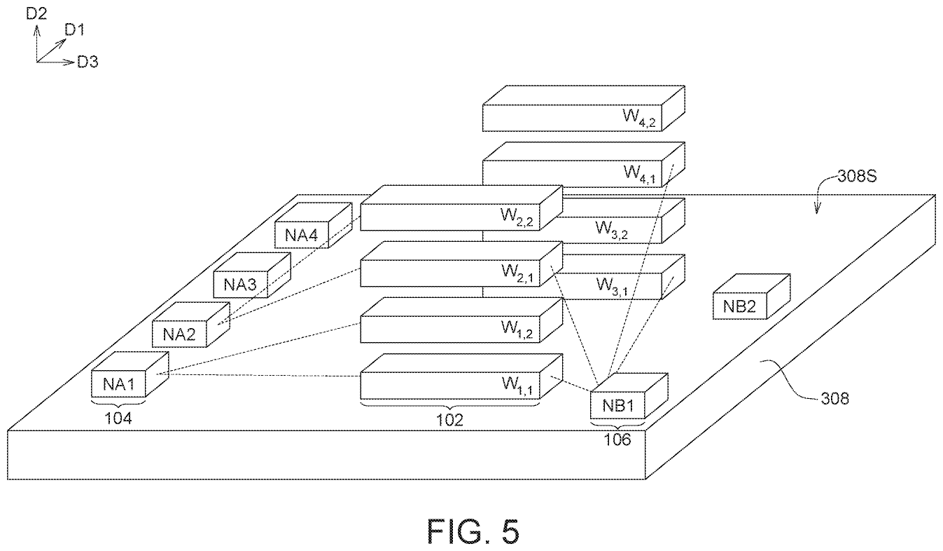

The synapse weights W_{i,j} are disposed in a synapse region 102. The first neural circuits NAi are disposed in a first neural region 104. The second neural circuits NBj are disposed in a second neural region 106. The first neural circuit NA1, the first neural circuit NA2 and the first neural circuit NA3 may be arranged along a direction D1 in sequence. The second neural circuit NB1, the second neural circuit NB2, the second neural circuit NB3 and the second neural circuit NB4 may be arranged along a direction D1 in sequence. The synapse weights W_{i,j} may be extended along a direction D3 For example, in an embodiment, the resistor of the synapse weight W_{i,j} may be extended along the direction D3. In an embodiment, the first neural region 104 and the second neural region 106 may be disposed at different sides of the synapse region 102, respectively. For example, in this embodiment, the first neural region 104 and the second neural region 106 may be disposed at opposing sides of the synapse region 102, respectively. In particular, the first neural region 104 may be disposed at a side 102M of the synapse region 102 having the signal input terminals Sin. The second neural region 106 may be disposed at a side 102 of the synapse region 102 having signal output terminals Sout, The signal input terminals Sin are between the first neural circuits NAi and the signal output terminal Souts. The signal output terminals Sout are between the second neural circuits NBj and the signal input terminals Sin. In an embodiment, the first neural region 104, the second neural region 106 and the synapse region 102 may be disposed on a substrate (such as a substrate 308 shown in FIG. 5, and non-overlapping with each other.

In embodiments, the synapse weights W_{i,j} may be defined into different synapse weight groups electrically connected to one of the first neural circuits NAi, and one of the second neural circuits NBj, respectively.

Referring to FIG. 1, in an embodiment, one of the first neural circuit NA1, the first neural circuit NA2 and the first neural circuit NA3 may be electrically connected to a first group of synapse weights arranged along a direction D2 as a column. A second group of synapse weights arranged along the direction D1 as a row may be electrically connected to one of the second neural circuit NB1, the second neural circuit NB2, the second neural circuit NB3 and the second neural circuit NB4. For example, in this embodiment, the first neural circuit NA1 is electrically connected to the synapse weight W_{1,1}, the synapse weight W_{1,2}, the synapse weight W_{1,3} and the synapse weight W_{1,4} of a first column group. The first neural circuit NA2 is electrically connected to the synapse weight W_{2,1}, the synapse weight W_{2,2}, the synapse weight W_{2,3} and the synapse weight W_{2,4} of a second column group. The first neural circuit NA3 is electrically connected to the synapse weight W_{3,1}, the synapse weight W_{3,2}, the synapse weight W_{3,3} and the synapse weight W_{3,4} of a third column group. The synapse weight W_{1,1}, the synapse weight W_{2,1}, and the synapse weight W_{3,1} of the same plane of a first row group are electrically connected to the second neural circuit NB1. The synapse weight W_{1,2}, the synapse weight W_{2,2}, and the synapse weight W_{3,2} of the same plane of a second row group are electrically connected to the second neural circuit NB2. The synapse weight W_{1,3}, the synapse weight W_{2,3}, and the synapse weight W_{3,3} of the same plane of a third row group are electrically connected to the second neural circuit NB3. The synapse weight W_{1,4}, the synapse weight W_{2,4}, and the synapse weight W_{3,4} of the same plane of a fourth row group are electrically connected to the second neural circuit NB4. In an embodiment, for example, a gap distance between the synapse weights may be equal to a gap distance between the first neural circuits. The amount of the second neural circuits may be equal to an amount of stacked layers of the synapse weights. However, the present disclosure is not limited thereto.

The direction D1, the direction D2 and the direction D3 may be different from each other. For example, the direction D1, the direction D2 and the direction D3 may be perpendicular to each other substantially. In an embodiment, for example, the direction D1 may be a Y direction. The direction D2 may be a Z direction. The direction D3 may be a X direction.

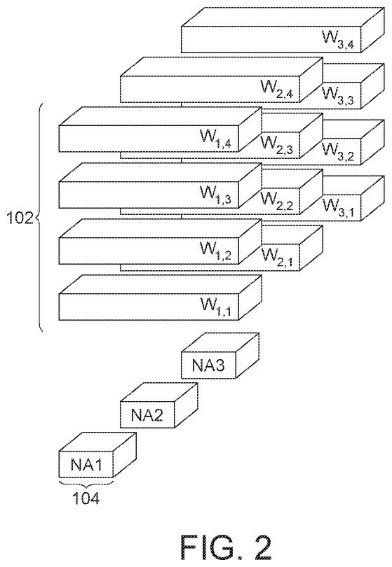

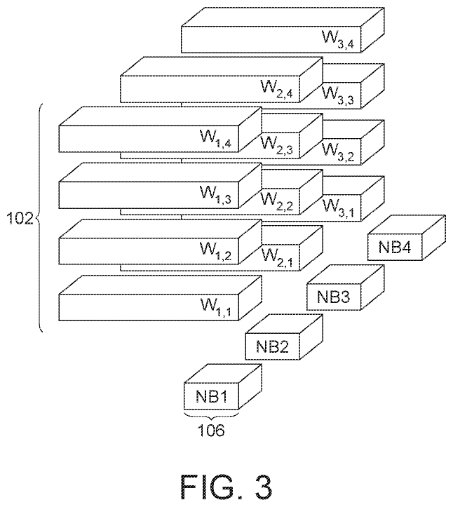

In other embodiments, the first neural region 104 and/or the second neural region 106 may be disposed under the synapse region 102, for example disposed on a side of the synapse region 102 facing towards a substrate (for example the substrate 308 shown in FIG. 5). For example, in an embodiment, as shown in FIG. 2, the first neural circuit NA1, the first neural circuit NA2 and the first neural circuit NA3 of the first neural region 104 may be disposed under the synapse region 102, for example disposed on a side of the synapse region 102 facing towards a substrate (for example the substrate 308 shown in FIG. 5). The first neural region 104 may be between the synapse region 102 and the substrate (such as the substrate 308 shown in FIG. 5). In an another embodiment, as shown in FIG. 3, the second neural circuit NB1, the second neural circuit NB2, the second neural circuit NB3 and the second neural circuit NB4 of the second neural region 106 may be disposed under the synapse region 102, for example disposed on a side of the synapse region 102 facing towards a substrate (for example the substrate 308 shown in FIG. 5). The second neural region 106 may be between the synapse region 102 and the substrate (such as the substrate 308 shown in FIG. 5).

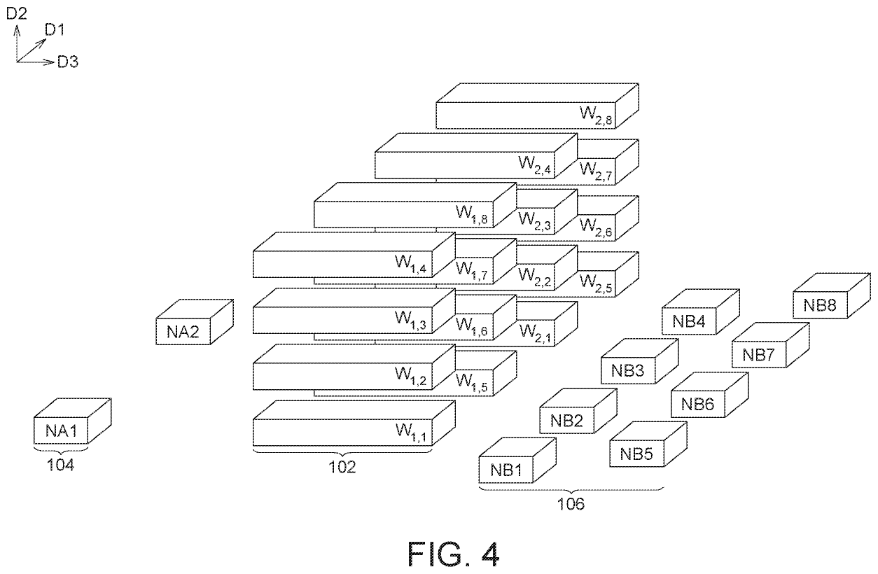

FIG. 4 illustrates a neuromorphic computing device, which is different from the neuromorphic computing device shown in FIG. 1 with the following illustrations. The first neural circuits NAi comprise the first neural circuit NA1 and the first neural circuit NA2. The second neural circuits NBj may further comprise a second neural circuit NB5, a second neural circuit NB6, a second neural circuit NB7 and a second neural circuit NB8 arranged along the direction D1 in sequence. The second neural circuits NB1-NB4 may be disposed between the synapse region 102 and the second neural circuits NB5-NB8. The second neural circuits NB1-NB4 may be disposed in a manner staggered with the second neural circuits NB5-NB8. The synapse weights W_{i,j} of the synapse units comprises the synapse weight W_{1,1}, the synapse weight W_{1,2}, the synapse weight W_{1,3} and the synapse weight W_{1,4} of a first column, the synapse weight W_{1,5}, the synapse weight W_{1,6}, the synapse weight W_{1,7} and the synapse weight W_{1,8} of a second column, the synapse weight W_{2,1}, the synapse weight W_{2,2}, the synapse weight W_{2,3} and the synapse weight W_{2,4} of a third column, and the synapse weight W_{2,5}, the synapse weight W_{2,6}, the synapse weight W_{2,7} and the synapse weight W8,8 of a fourth column.

In an embodiment, one of the first neural circuits may be electrically connected to the first group of synapse weights arranged as columns in an array. The second group of synapse weights arranged alternately in the direction D1 may be electrically connected to one of the second neural circuits. For example, in this embodiment, the first neural circuit NA1 is electrically connected to the group of the synapse weights W_{1,1}-W_{1,8} of the first column and the second column. The first neural circuit NA2 is electrically connected to the group of the synapse weights W_{2,1}-W_{2,8} of the third column and the fourth column. The group of the synapse weight W_{1,1} and the synapse weight W_{2,1} arranged alternately is electrically connected to the second neural circuit NB1. The group of the synapse weight W_{1,2} and the synapse weight W_{2,2} arranged alternately is electrically connected to the second neural circuit NB2. Connection relations of the other synapse weights and second neural circuits may be analogous thereto.

FIG. 5 illustrates a neuromorphic computing device, which is different from the neuromorphic computing device shown in FIG. 1 with the following illustrations. The first neural circuits further comprise a first neural circuit NA3 and a first neural circuit NA4. The first neural circuits NA1 to NA4 are arranged along the direction D1 in sequence. The second neural circuits comprise the second neural circuit NB1 and the second neural circuit NB2. The synapse weights of the synapse units comprise the synapse weight W_{1,1}, the synapse weight W_{1,2}, the synapse weight W_{2,1} and the synapse weight W_{2,2} of a first column arranged along the direction D2, and the synapse weight W_{3,1}, the synapse weight W_{3,2}, the synapse weight W_{4,1} and the synapse weight W_{4,2} of a second column arranged along the direction D2.

In an embodiment, one of the first neural circuits may be electrically connected to a portion of the synapse weights of one column of a first group. A second group of synapse weights arranged alternately in the direction D2 of columns may be electrically connected to one of the second neural circuits. For example, in this embodiment, the first neural circuit NA1 is electrically connected to the group of the synapse weight W_{1,1} and the synapse weight W_{1,2} in a lower portion of the first column. The first neural circuit NA2 is electrically connected to the group of the synapse weight W_{2,1} and the synapse weight W_{2,2} in an upper portion of the first column. Connection relations of the other synapse weights and first neural circuits may be analogous thereto. A group of the synapse weight W_{1,1} and the synapse weight W_{2,1} arranged alternately in the first column, and the synapse weight W_{3,1} and the synapse weight W_{4,1} arranged alternately in the second column is electrically connected to the second neural circuit NB1. A group of the synapse weight W_{1,2}, the synapse weight W_{2,2}, the synapse weight W_{3,2} and the synapse weight W_{4,2} is electrically connected to the second neural circuit NB2. In this embodiment, the first neural region 104, the second neural region 106 and the synapse region 102 are disposed on an upper surface 308S of the substrate 308, and are non-overlapping with each other.

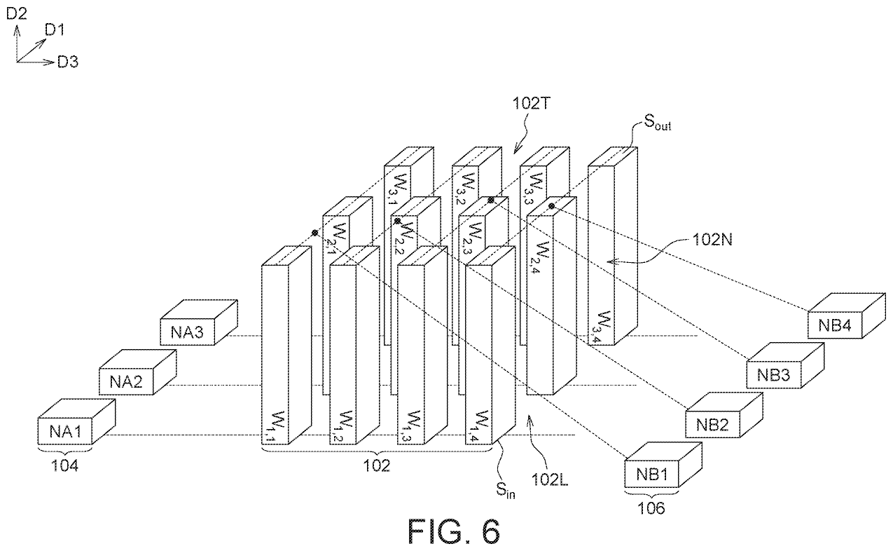

FIG. 6 illustrates a neuromorphic computing device, which is different from the neuromorphic computing device shown in FIG. 1 with the following illustrations. The synapse weights W_{i,j} (i=1, 2, 3; j=1, 2, 3, 4) may be extended along the direction D2. For example, in an embodiment, the synapse weight W_{i,j} comprises a resistor. The resistor of the synapse weight W_{i,j} may be extended along the direction D2. In an embodiment, the signal output terminals Sout and/or the signal input terminals Sin of the synapse weights W_{i,j} may be at a side of the synapse region 102 not facing towards the first neural region 104 and/or the second neural region 106. For example, the signal output terminals Sout are at a side 102T of the synapse region 102, the signal input terminals Sin are at a side 102L of the synapse region 102 opposing to the side 102T. For example, the side 102T of the synapse region 102 may be back to a substrate (such as the substrate 308 shown in FIG. 5). The side 102L of the synapse region 102 may face towards the substrate.

In an embodiment, one of the first neural circuits may be electrically connected to a first group of synapse weights arranged along the direction D3. A second group of synapse weights arranged along the direction D1 may be electrically connected to one of the second neural circuits. For example, in this embodiment, the first neural circuit NA1 is electrically connected to a group of the synapse weight W_{1,1}, the synapse weight W_{1,2}, the synapse weight W_{1,3} and the synapse weight W_{1,4}. The first neural circuit NA2 is electrically connected to a group of the synapse weight W_{2,1}, the synapse weight W_{2,2}, the synapse weight W_{2,3} and the synapse weight W_{2,4}. The first neural circuit NA3 is electrically connected to a group of the synapse weight W_{3,1}, the synapse weight W_{3,2}, the synapse weight W_{3,3} and the synapse weight W_{3,4} of a group. A group of the synapse weight W_{1,1}, the synapse weight W_{2,1}, and the synapse weight W_{3,1} is electrically connected to the second neural circuit NB1. A group of the synapse weight W_{1,2}, the synapse weight W_{2,2}, and the synapse weight W_{3,2} is electrically connected to the second neural circuit NB2. Connection relations of the other synapse weights and second neural circuits may be analogous thereto.

However, the present disclosure is not limited thereto. In an another embodiment, the signal input terminals Sin of the synapse weights are at the side 102T of the synapse region 102, and the signal output terminals Sout are at the side 102l opposing to the side 102T.

In other embodiments, one of the first neural region 104 (or the first neural circuits NAi) and the second neural region 106 (or the second neural circuits NBj) may be disposed at the side 102L of the synapse region 102 (or the synapse weights W_{i,j}) facing towards a substrate, For example, the one of the first neural region 104 (or the first neural circuits NAi) and the second neural region 106 (or the second neural circuits NBj) may be disposed between the synapse region 102 (or the synapse weights W_{i,j}) and an upper surface of the substrate (such as the upper surface 308S of the substrate 308 shown in FIG. 5), or disposed in the substrate, i,e, an inner substrate portion under the upper surface of the substrate.

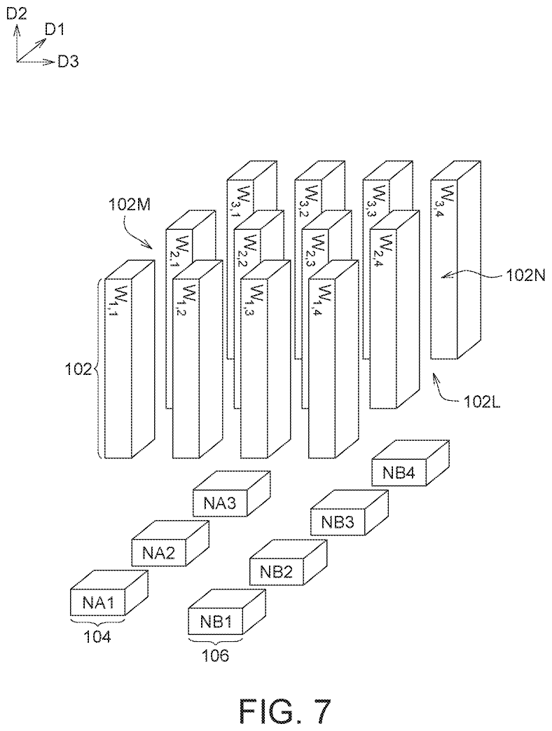

FIG. 7 illustrates a neuromorphic computing device, which is different from the neuromorphic computing device shown in FIG, 6 with the following illustrations. In this embodiment, the first neural region 104 (or the first neural circuits NAi) and the second neural region 106 (or the second neural circuits NBj) may be disposed on the side 102L of the synapse region 102 (or the synapse weights W_{i,j}) facing towards a substrate (such as the substrate 308 shown in FIG. 5. For example, the first neural region 104 (or the first neural circuits NAi) and the second neural region 106 (or the second neural circuits NBj) may be disposed between the synapse region 102 (or the synapse weights W_{i,j}) and an upper surface of the substrate (such as the upper surface 308S of the substrate 308 shown in FIG. 5), or disposed in the substrate, i.e. an inner substrate portion under the upper surface of the substrate.

In an another embodiment, the first neural region 104 (or the first neural circuits NAi) may be disposed on the side 102L of the synapse region 102 (or the synapse weights W_{i,j}) facing towards a substrate. For example, the first neural region 104 (or the first neural circuits NAi) may be disposed between the synapse region 102 (or the synapse weights W_{i,j}) and the upper surface of the substrate or disposed in the substrate, while the second neural region 106 (or the second neural circuits NBj) may be disposed on the side 102N of the synapse region 102 similar to FIG. 6.

In a yet another embodiment, the second neural region 106 (or the second neural circuits NBj) may be disposed on the side 102L of the synapse region 102 (or the synapse weights W_{i,j}) facing towards a substrate. For example, the second neural region 106 (or the second neural circuits NBj) may be disposed between the synapse region 102 (or the synapse weights W_{i,j}) and the upper surface of the substrate or disposed in the substrate, while the first neural region 104 (or the first neural circuits NAi) may be disposed on the 102M of the synapse region 102 opposing to the side 102N.

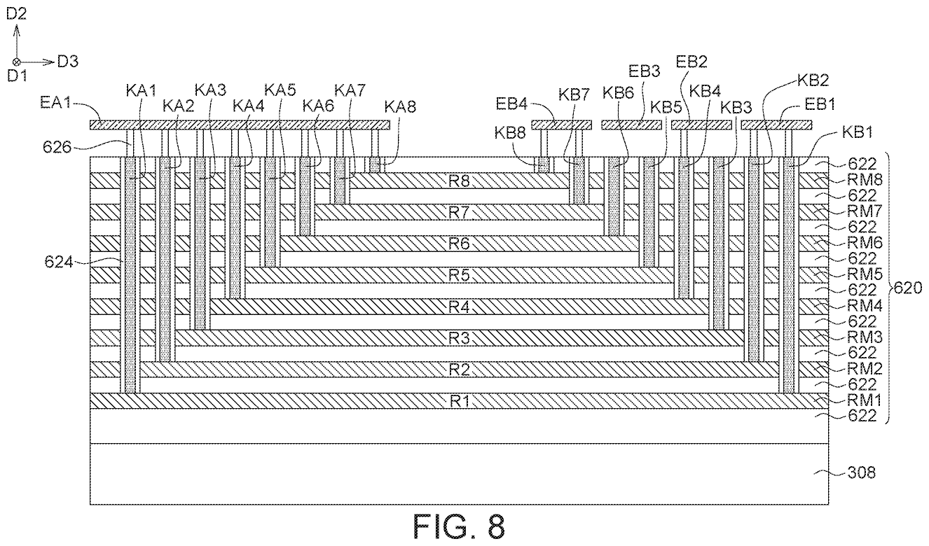

FIG. 8 illustrates a cross-section view of synapse weights having a 3D horizontal resistor structure according to an embodiment. A stack structure 620 may be disposed on the substrate 308. The stack structure 620 may comprise insulating layers 622 and a resistive material layer RM1 of a first layer, a resistive material layer RM2 of a second layer . . . and a resistive material layer RM8 of an eighth layer stacked on the upper surface 308S of the substrate 308 in sequence stacked alternately along the direction D2.

Insulating films 624 may be formed in the stack structure 620. Conductor elements KA1-KA8 and conductor elements KB1-KB8 may be formed on sidewall surfaces of the insulating films 624, and extended into the stack structure 620 along the direction D2 from an upper surface of the stack structure 620 to be electrically connected on one of the resistive material layers RM1-RM8.

The conductor element KA1 and the conductor element KB1 as a pair are in contact with different portions of the resistive material layer RM1 in the direction D3, which defines a unit resistor R1 electrically connected between the conductor element KA1 and the conductor element KB1 in the resistive material layer RM1 and extending along the direction D3. A portion of the resistive material layer RM1 (or the unit resistor R1) being in contact with conductor element KA1 may be regarded as the signal input terminal Sin of the resistor of the synapse weight, and a portion of the resistive material layer RM1 (or the unit resistor R1) being in contact with conductor element KB1 may be regarded as the signal output terminal Sout of the resistor of the synapse weight. The conductor element KA8 and the conductor element KB8 as a pair are in contact with different portions of the resistive material layer RM8 in the direction D3, which defines a unit resistor R8 electrically connected between the conductor element KA8 and the conductor element KB8 in the resistive material layer RM8 and extending along the direction D3. A portion of the resistive material layer RM8 (or the unit resistor R8) being in contact with conductor element KA8 may be regarded as the signal input terminal Sin of the resistor of the synapse weight, and a portion of the resistive material layer RM8 (or the unit resistor R8) being in contact with conductor element KB8 may be regarded as the signal output terminal Sout of the resistor of the synapse weight. Definition for unit resistors R2-R7 in the resistive material layer RM2-RM7 with the other conductor elements, and the signal input terminals Sin and the signal output terminals Sout of the unit resistors R2-R7 respectively may be analogous thereto,

Contact vias 626 may be disposed on the conductor elements. In this embodiment, the contact vias 626 are disposed on the conductor elements KA1-KA8 and the conductor elements KB1-KB2, KB4, and KB7-KB8. A conductor layer may comprise an input conductor portion EA1, an output conductor portion EB1, an output conductor portion EB2, an output conductor portion EB3 and an output conductor portion EB4 separated from each other. The input conductor portion EA1, the output conductor portion EB1, the output conductor portion EB2, and the output conductor portion EB4 are disposed on the contact vias 626. The input conductor portion EA1 may be electrically connected to the conductor elements KA1-KA8 through the contact vias 626. The output conductor portion EB1 may be electrically connected to the conductor element KB1 and the conductor element KB2 through the contact vias 626. The output conductor portion EB2 may be electrically connected to the conductor element KB3 and the conductor element KB4 through the contact vias 626. The output conductor portion EB3 is not electrically connected to the contact via 626, and may be electrically insulated from the conductor element KB5 and the conductor element KB6 by an insulating layer (not shown) formed on the conductor elements, The output conductor portion EB4 may be electrically connected to the conductor element KB7 and the conductor element KB8 through the contact vias 626.

In embodiments, the resistances of the resistive material layers may be larger than the resistances of the conductor elements, the conductor layer and the contact vias so that a total effective resistance of the resistor circuit would be substantially constructed by the unit resistors in the resistive material layers. For example, the conductor elements, the conductor layer and the contact vias may be contact elements having high conductivity, The resistive material layers may comprise a semiconductor material such as a N-type semiconductor material or a P-type semiconductor material, for example doped with dopants of R B, In, C, N and so on, or a carbon based material, or a metal nitride such as TiN, TaN, but are not limited thereto, The resistive material layers may use other suitable resistor materials. The conductor elements, the conductor layer and the contact vias may comprise a suitable metal such as W, Al, Cu, or a metal silicide or other suitable material having a high conductivity, but the present disclosure is not limited thereto.

Referring to FIG. 8, for example, a neural signal from the first neural circuits NA1 may be transferred to signal input terminals Sin of the unit resistors R1 and R2 through a conductor circuit (which may comprise the input conductor portion EA1, the contact vias 626 electrically connected with the input conductor portion EA1, or other suitable conductor circuit elements) to get into a parallel resistor substantially constructed by the unit resistors R1 and R2, and then be converted into a weighted signal by the parallel resistor. Then, the weighted signal may be transferred from the signal output terminals Sout of the parallel resistor to the second neural circuit NB1 through an another conductor circuits (which may comprise the output conductor portion EB1, the contact vias 626 electrically connected with the output conductor portion EB1, or other suitable conductor circuit elements). For example, the parallel resistor substantially constructed by the unit resistors R1 and R2 may be used as the synapse weight W_{1,1} as shown in FIG. 1. The synapse weight W_{1,2} (for example in FIG. 1) comprising the unit resistors R3, and a parallel resistor constructed by the unit resistors R7 and R8 in FIG. 8 as the synapse weight W_{1,4} (for example in FIG. 1) are analogous thereto. The unit resistor R3 is floating since it is not electrically connected to the output conductor portion EB2. Therefore, the weighted signal of the synapse weight W_{1,2} (FIG. 1, for example) is not resulted through the unit resistor R3. The unit resistor R5 and the unit resistor R6 are floating since they are not electrically connected to the output conductor portion EB3. Therefore, the weighted signal of the synapse weight W_{1,3} is not resulted through the unit resistor R5 and the unit resistor R6. Similarly, the neural signals from the first neural circuit NA1 may be converted into weighted signals through the synapse weight W_{1,2}, the synapse weight W_{1,3} and the synapse weight W_{1,4}, and then the weighted signals are transferred to the second neural circuit NB2, the second neural circuit NB3 and the second neural circuit NB4, respectively.

In embodiments, arrangements of the resistive material layers, the conductor elements, the contact vias and the conductor layer may be properly varied according to actual demands for obtaining synapse weights having expected weight values. For example, resistances of the unit resistors of different layers may be the same or different flexibly varied by controlling factors influencing effective resistance such as a shape, a gap distance, a contact area with the resistive material layer, or contact location with the resistive material layer of the corresponding pair of the conductor elements, and/or a size, a material, or a shape of the resistive material layers, or other factors. For example, the resistive material layers may have the same or different thickness. The resistive material layers may have the same or different material characteristic. The resistive material layer may comprise a semiconductor material such as a silicon material such as poly-silicon, or a carbon based material, or a metal nitride such as TiN, TaN, etc., or other suitable resistor materials. The resistive material layer may comprise a N-type semiconductor material or a P-type semiconductor material. For example, the resistive material layers may have the same or different doped characteristic. For example, the resistive material layers may have the same or different dopant impurity, and/or have the same or different dopant concentration. The dopant impurity may comprise an element of P, B, In, C, N and so on.

However, the present disclosure is not limited thereto. For example, in an embodiment, the synapse weights W_{1,1}-W_{1,4} and/or the other synapse weights W_{i,j} may be defined into different groups respectively in different stack structures. The synapse weights may be arranged as a plane array or a 3D array. In other embodiments, the synapse weight may comprise a 2D resistor structure or other suitable synapse weight structure. For example, the synapse weights may comprise transistors.

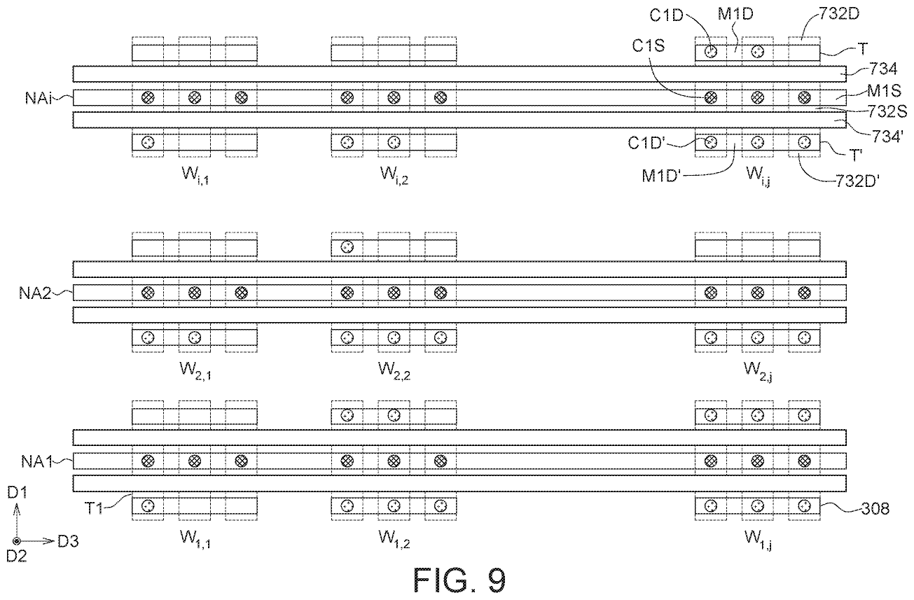

FIG. 9 illustrates a top view of a neuromorphic computing device having transistors according to an embodiment. Each of transistors one the same plane comprises a substrate, a source, a drain, and a gate. For example, each of transistors T comprises the substrate 308, a source/drain 732S, a source/drain 732D, and a gate 734. The source/drain 732S and the source/drain 732D of transistors T are in substrate 308 on opposing sides of the gate 734 respectively. Each of transistors T′ comprises the substrate 308, the source/drain 732S, a source/drain 7320′, and a gate 734′. The source/drain 732S and the source/drain 732D′ of transistors T′ are in substrate 308 on opposing sides of the gate 734′ respectively. The transistor T and the transistor T′ may share the source/drain 732S. In an embodiment, the source/drain 732S is a source, and the source/drain 732D and source/drain 732D′ are drains. The gate 734 (or the gate 734′) may be extended along the direction D3, so that the transistors T (or the transistors T′) arranged along the direction D3 may have a common gate. A first conductive element C1S may be formed on the source/drain 732S. A first conductive element C1D may be formed on the source/drain 732D. A first conductive element C1D′ may be formed on the source/drain 732D′. In an embodiment, the first conductive elements C1S, the first conductive elements C1D and the first conductive elements C1D′ are contact elements.

In embodiments, the synapse weights have different transistor arrangements so as to have different weight values. In an embodiment, the weight value of the synapse weight may be defined according to an amount of active transistor of the synapse weight. For example, a synapse weight W_{1,1} as shown in FIG. 9 comprises a transistor T1. The first conductive element C1D′ is disposed on the source/drains 104D′ of the transistor T1. As such, the transistor T1 may be regarded as an active transistor. In addition, a neural signal from the first neural circuit NAi is transferred into the transistor T1 of the synapse weight W_{1,1} through the first conductive elements C1S and converted into a weighted signal by the transistor T1, and then the weighted signal is transferred from the synapse weight W_{1,1} through the first conductive element C1D′ to the second neural circuit NBj. In other words, the weight value of the synapse weight W_{1,1} is generated from one transistor T′ (i.e. the transistor T1). The other transistors of the synapse weight W_{1,1} are regarded as dummy transistors since the source/drains 732D and the source/drains 732D′ of the other transistors are floating and no signal is transferred to second neural circuit NBj from the source/drain 732D and the source/drains 732D′ of the other transistors. Weight values of the other synapse weights may be analogous thereto. The first conductive layer M1D (first conductive layer M1D′) may be extended along the direction D3, and disposed on the first conductive element C1D (first conductive element C1D′) and the inter-layer dielectric (not shown). In an embodiment, the first conductive element C1D (first conductive element C1D′) and the first conductive layer M1D (first conductive layer M1D′) may be electrically connected between the source/drain 732D (source/drain 732D′) of the active transistor and the second neural circuit NBj. The source/drain 732D (source/drain 732D′) of the dummy transistor may be isolated from the first conductive layer M1D (first conductive layer M1D′) by the inter-layer dielectric (not shown) so as to be electrically isolated from the second neural circuit NBj. In embodiments, 54 transistors on the same plane as shown in FIG. 9 define out 9 synapse weights. Each of the synapse weights has 6 transistors, i.e. 3 transistors T and 3 transistors T′. In an embodiment, weight values of the synapse weights as shown in FIG. 9 may comply with W_{1,1}:W_{1,2}:W_{1,j}:W_{2,1}:W_{2,2}:W_{2,j}:W_{i,1}:W_{i,2}:W_{i,j}=1:5:6:2:4:3:1:2:5. In an embodiment, the first conductive layers M1S, the first conductive layers M1D and the first conductive layers M1D′ may be a first metal layer.

While the disclosure has been described by way of example and in terms of the exemplary embodiment(s), it is to be understood that the disclosure is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A neuromorphic computing device, comprising:
first neural circuits disposed in a first neural region;
second neural circuits disposed in a second neural region; and
synapse weights electrically connected between the first neural its and the second neural circuits, and disposed in a synapse region, wherein the first neural region and the second neural region are on opposing sides of the synapse region respectively.

2. The neuromorphic computing device according to claim 1, comprising resistive material layers and insulating layers stacked alternately, wherein one of the synapse weights comprises at least one of the resistive material layers.

3. The neuromorphic computing device according to claim 1, comprising transistors on the same plane, wherein one of the synapse weights comprises at least one of transistors.

4. The neuromorphic computing device according to claim 1, wherein each of the synapse weights comprises a signal input terminal and a signal output terminal, the signal input terminals are between the first neural circuits and the signal output terminals, the signal output terminals are between the second neural circuits and the signal input terminals.

5. The neuromorphic computing device according to claim 1, wherein the synapse weights are defined into different synapse weight groups electrically connected to one of the first neural circuits, and one of the second neural circuits respectively.

6. The neuromorphic computing device according to claim 1, wherein one of the first neural circuits arranged along a direction is electrically connected to a first group of synapse weights arranged along an another direction of the synapse weights, a second group of synapse weights arranged along the direction of the synapse weights is electrically connected to one of the second neural circuits arranged along the direction.

7. The neuromorphic computing device according to claim 6, wherein each of the synapse weights comprises a resistor, extended along a yet another direction.

8. The neuromorphic computing device according to claim 1, wherein one of the first neural circuits arranged along a direction is electrically connected to a first group of synapse weights arranged along the direction of the synapse weights, a second group of synapse weights arranged along an another direction of the synapse weights is electrically connected to one of the second neural circuits arranged along the direction.

9. The neuromorphic computing device according to claim 7, wherein each of the synapse weights comprises a resistor, extended along a yet another direction.

10. The neuromorphic computing device according to claim 1, wherein the synapse region, the first neural region and the second neural region are non-overlapping with each other.

11. The neuromorphic computing device according to claim 1, further comprising a substrate under the first neural circuits, the second neural circuits, and the synapse weights.

12. A neuromorphic computing device, comprising:
a substrate;
synapse weights on the substrate; and
neural circuits electrically connected to the synapse weights, and disposed on a side of the synapse weights facing towards the substrate.

13. The neuromorphic computing device according to claim 12, wherein the neural circuits comprise first neural circuits disposed at the side of the synapse weights facing towards the substrate.

14. The neuromorphic computing device according to claim 13, wherein the neural circuits further comprise second neural circuits disposed at the side of the synapse weights facing towards the substrate, the synapse weights are electrically connected between the first neural circuits and the second neural circuits.

15. The neuromorphic computing device according to claim 12, wherein the neural circuits comprises second neural circuits disposed at the side of the synapse weights facing towards the substrate.

16. The neuromorphic computing device according to claim 12, wherein each of the synapse weights comprises a signal input terminal and a signal output terminal, one of the signal input terminal and the signal output terminal is at the side of the synapse weights facing towards the substrate, the other of the signal input terminal and the signal output terminal is on an another side of the synapse weights back to the substrate.

17. The neuromorphic computing device according to claim 12, wherein the neural circuits comprise first neural circuits and second neural circuits, each of the synapse weights comprises a signal input terminal and a signal output terminal, neural signals from the first neural circuits are transferred into the synapse weights through the signal input terminals and converted into weighted signals by the synapse weights, and then the weighted signals are transferred from the synapse weights through the signal output terminal to the second neural circuits.

18. The neuromorphic computing device according to claim 12, wherein the synapse weights are defined into different synapse weight groups electrically connected to one of the first neural circuits, and one of the second neural circuits respectively.

19. The neuromorphic computing device according to claim 12, comprising resistive material layers and insulating layers stacked alternately, wherein one of the synapse weights comprises at least one of the resistive material layers.

20. The neuromorphic computing device according to claim 12, comprising transistors on the same plane, wherein one of the synapse weights comprises at least one of transistors
